(19) United States
(12) Patent Application Publication
(10) Pub. No.: US 2006/0080183 A1
(43) Pub. Date: Apr. 13, 2006

(54) Network system for handling on-line auctions

(76) Inventor: Richard Cicotelli, Upper Darby, PA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/148,485

(22) Filed: Jun. 9, 2005

Related U.S. Application Data
(60) Provisional application No. 60/579,133, filed on Jun. 9, 2004.

(51) Int. Cl. G06Q 30/00

(52) U.S. Cl. 705/26

(57) ABSTRACT

An method for controlling an auction and sale of products between a vendor and a seller comprising: placing an item for sale on an auction site such that the price of the item fluctuates according to a preset algorithm based upon time and the level of sales; completing a sale of at least one of the items; and delivering the goods to the customer.

### CLAIM OF PRIORITY

This application claims benefit to provisional application 60/579,133, filed on Jun. 9, 2004, entitled “Network System for Handling Online Auctions,” which is incorporated herein by reference in its entirety.

### FIELD OF THE INVENTION

The present invention is directed to online computer systems. In particular, the present invention is specifically directed to online computer systems which can be used to handle the running of auctions and the like.

### BACKGROUND OF THE INVENTION

The Internet or World Wide Web is one of the most critical technological developments of the 1990's. The Internet has provided vast economic opportunities for numerous businesses and industries to vastly expand the number and quality of their services. One of the earliest and fastest emerging areas of Internet activity has been in providing rapid, up-to-the-minute business information. To date, a number of patents have issued on Internet related systems that cover a wide array of business information and electronic commerce (e-commerce) applications.

One of the earliest and largest uses of the Internet has been in the field of auctions. Since its earliest inception, the Internet has been utilized for matching sellers with buyers. A large number of highly acclaimed and popular websites have been directed toward online auctions, most notably, eBay.

U.S. Pat. No. 6,269,343 to Pallakoff discloses a method and system that allows sellers to communicate conditional offers to potential buyers. The conditions include prices that depend on the aggregate amount of goods or services that buyers collectively agree to purchase by a given time and date. The invention facilitates “demand aggregation”, that is, aggregating demand by potential buyers (who may or may not know each other), for products offered by sellers. This invention allows sellers conveniently to offer “Demand-Based Pricing”, that is, prices which go down as the volume of units sold in any given offer goes up. A seller can therefore offer volume discounts to buyers acting as a group, even when the buyers may not have any formal relationship with one another.

U.S. Pat. No. 6,604,089 to Van Horn discloses to an online buying group (referred to herein as a “coop”) is formed for the specific purpose of purchasing a particular product at (102) by defining a start time, end time, critical mass, any minimum number of units offered, any maximum number of units offered, starting price and product cost curve. As data is gathered from buyers, by means of their making binding purchase offers, the co-op is modified at (108) using a pricing tool, so as to take into account for this market data in the definition of the price curve. A buyer chooses a product co-op of interest. The buyer is presented with the following essential co-op information: current price, closing time, next price level (as defined by a price curve visibility window and the price curve) sufficient to entice the buyer to make an offer. Once a buyer has made up his mind, the decision must be made to offer a purchase price which includes the current price, guaranteeing availability if critical mass has been achieved, or to make an offer at a lower price range that can be accepted only if the co-op price drops to that level, which may not occur. Given a decision to make an offer at such lower price, the buyer enters such maximum price at which he is willing to purchase the product at (118). Should the current price drop to the level at which the offer was made, the price contingency is removed from such offer and assuming critical mass is achieved, the offer is accepted at the close of the co-op at (122), and processed accordingly. Inventory is allocated to fulfill the accepted offer at (126) following the closing of the co-op at (124).

U.S. Published application No. 2003/0139996 to D'Antoni discloses a method for facilitating the purchase of goods and services of a targeted population, typically of medium to small-sized industrial manufacturers, fabricators and others, at a lower total cost. A facilitating entity establishes and acts as the hub of a trading network and provides multiple value-added services to facilitate trade through that hub. The facilitating entity establishes business relationships with selected suppliers of goods and services and with business partners. The facilitating entity negotiates attractive prices with the suppliers given the volume purchases of its business partners and of the business partner customers. The facilitating entity also establishes an information processing system that provides access to the trading network's suppliers by the business partners and the business partner customers and their employees. The resulting arrangement is mutually beneficial to the business partners, customers and suppliers, enabling all three to realize increased efficiencies and profitability.

U.S. Published application No. 2003/0061147 to Fluhr discloses a system 10 for providing logistics for a sale of goods. The system may be implemented over a global computer network 20, and is effective to provide financial logistics for a sale of goods between a seller and a remote buyer, in a manner that does not require interaction between the seller and buyer. The system 10 further implements a geography-based and time-based strategy for executing the logistics of shipping time-sensitive goods from the seller to the buyer.

International Application No. WO 00/48104 to Grossman discloses an interactive website on the Internet posts information regarding products and services, each product or service being offered for sale at an initial offering price with at least one lower alternative sales price, which can become the final sales price, being posted. The applicability of the lower price is contingent upon the confirmation of a specified number of prospective sales for that product or service. Confirmed individual purchase orders are cumulatively totaled over time to effect incremental cost reductions for the entire class of purchasers of a given product or service, or for a group of related products or services. Fulfillment of the confirmed purchase order is preferably affected from inventory held by the product's manufacturer, a regional distributor of the product or a merchant dealing in the product, thereby further reducing the cost associated with each individual sale.

International Application No. WO 01/13216 to McClung discloses a method for guaranteeing a consumer a best price on subject matter purchased from a vendor in a first transaction at a first price, the method including recording the first price and information identifying the consumer, monitoring sales prices of the subject matter for a predetermined time period, calculating after the price transaction, noting any price lower than the first price during the predetermined time period, calculating a money-value difference between the first price and said any price lower than the first price, and refunding to the consumer an amount equal to the money-value difference, wherein the subject matter is purchased via a host system and the host system records the first price and information identifying the customer, the host system conducts the monitoring.

International Application No. WO 03/027808 to Liquidseats, Inc. discloses a system for providing logistics for the sale of goods. The system may be implemented over a global computer network, and is effective to provide financial logistics for the sale of goods between a seller and a remote buyer, in a manner that does not require interaction between the seller and buyer. The system further implements a geography-based and time-based strategy for executing the logistics of shipping time-sensitive goods from the seller to the buyer.

While there have been a number of websites and applications, there has not been a system which facilitates one or more timed auctions where pricing drops or rises a predetermined amount based upon an algorithm. The algorithm can be based to drop the sales based upon a preset number of sales, based upon the time left in the auction and the number of units which are sold per hour. The system thus provides sellers with the opportunity and ability to sell excess merchandise and to achieve a pre-selected price. None of the prior art is directed to a system in which the seller drop ships and the customer receives the product at a specific price.

Such a system would be desirable because there is an ongoing need to provide such services. It is therefore an object of the present invention to provide a system, accessible via a computer network, for providing means for persons to conduct an online auction.

It is a further object of the present invention to provide a system in which users and subscribers access the system via the Internet or World Wide Web and can be provided with a user interface which handles online auctions.

It is still a further object of the present invention to provide a system whereby the online auctions can be run over a pre-set period of time and prices can fluctuate with demand and/or time.

These and other objects of the present invention will become apparent from the detailed description and from the following summary, detailed description and claims.

### SUMMARY OF THE INVENTION

In accordance with the invention, a method for controlling an auction and sale of products between a vendor and a seller comprising: placing an item for sale on an auction site such that the price of the item fluctuates according to a preset algorithm based upon time and the level of sales; completing a sale of at least one of the items; and delivering the goods to the customer.

In a further embodiment, the invention is an interface for controlling a live auction comprising: a vendor interface for permitting at least one vendor to place products for sale and to set a price which fluctuates based upon time or demand; a customer interface wherein a customer may order and purchase products and observe whether the price is rising or lowering; and a delivery system to deliver the purchased product;

In still a further embodiment, the invention is a method for controlling an auction and sale of products between a vendor and a seller comprising: placing an item for sale on an auction site such that the price of the item fluctuates according to a preset algorithm based upon time and the level of sales; indicating whether the price is rising or lowering, based upon a previous sale price; completing a sale of at least one of the items; and delivering the goods to the customer.

In yet a further embodiment, an interface for controlling a live auction comprising: a vendor interface for permitting a plurality of vendors to place products for sale and to set a price which fluctuates based upon time and demand; a customer interface wherein a customer may order and purchase products; and a delivery system to deliver the goods.

### BRIEF DESCRIPTION OF THE FIGURES

FIG. 1 is a block diagram of the on-line components present invention.

FIG. 2 is a detailed block diagram of the system of the present invention.

FIG. 3 is a diagram of the database of the present invention.

FIGS. 4 to 9 illustrate a series of input screens for use by vendors and customers in conjunction with the present invention.

### DETAILED DESCRIPTION OF THE PREFERRED EMBODIMENT

The present invention is directed to a system for conducting a specialized auction over a communication network using, for example, personal computers and similar devices. In particular, the present invention is being described in the context of a system using a personal computer. The manner of the end user device is not critical to the present invention. The present invention may be used with any system that connects to the Internet or uses other IP transport methods. The end user device can comprise any end user device which can connect to a network such as a wireless device, palm pilot, PDA, end user work station or hand-held device.

In a most preferred embodiment, the present invention is directed to a system for facilitating on line auctions. The present invention is broadly directed to a computer network for facilitating a novel and unique auctioning system. The present invention is designed, in one embodiment, to be utilized on the World Wide Web or Internet, although the present invention is equally applicable to other network environments. As noted above, the present invention is similarly related to user interfaces which are not computers such as palm pilots, wireless and cellular devices.

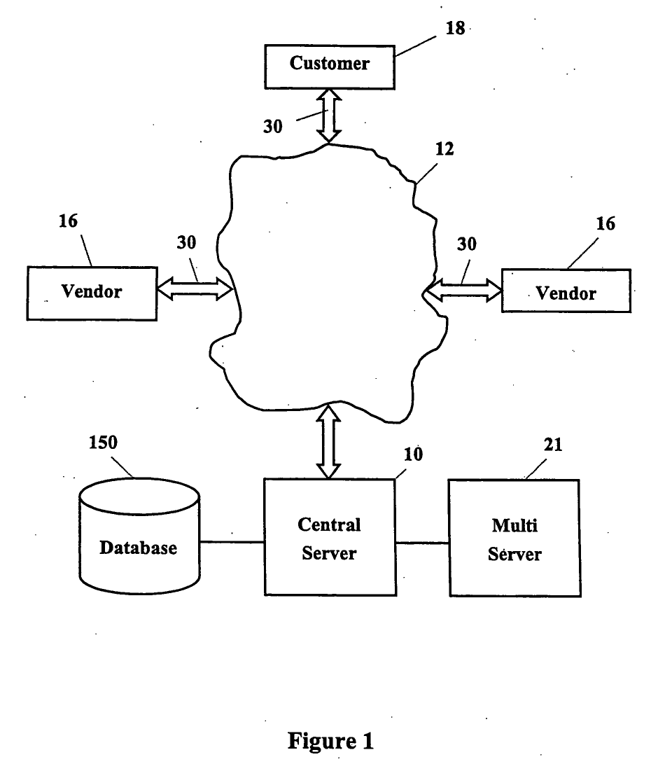

Referring to FIG. 1, a most preferred embodiment of the present invention is disclosed and shown. The most preferred embodiment comprises a central computer server 10 connected by a computer network 12 to remote end user stations 14. The central server connects to a database 150. In a preferred embodiment, end user stations 14 comprise a plurality of end users 16, 18. End users 16, 18 are defined herein as individuals linked to the system who may comprise customers 18 and vendors 16. For purposes of this disclosure, an end user is defined as an individual who seeks to purchase products. A vendor is defined as an entity which puts a product up for auction. Users 16, 18 are linked with the central computer server 10 via a transport medium 30. End users 16, 18 will typically comprise sellers and buyers who, in a most preferred embodiment, will be linked via a global computer network 12 such as the Internet or Worldwide web, but other embodiments including LANs, WANs and Intranets, fulfill the spirit and scope of the present invention.

The end user's devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system and system clients through a communication link and transport medium 30.

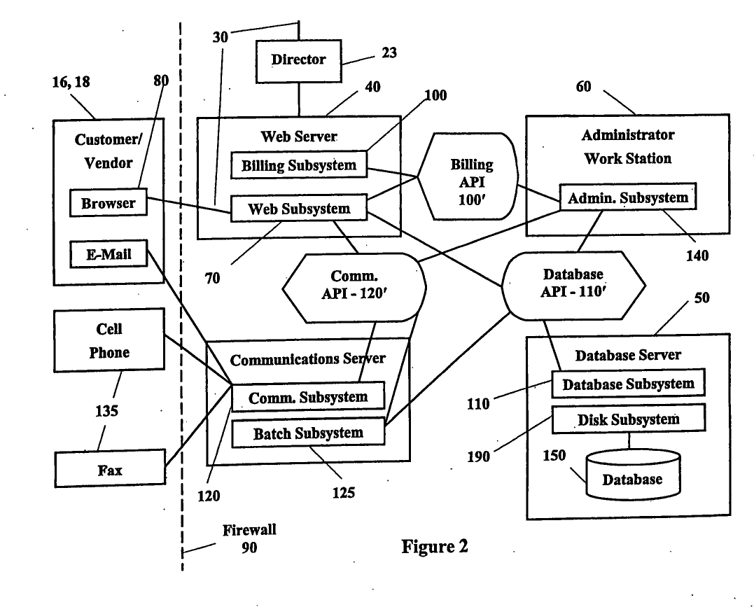

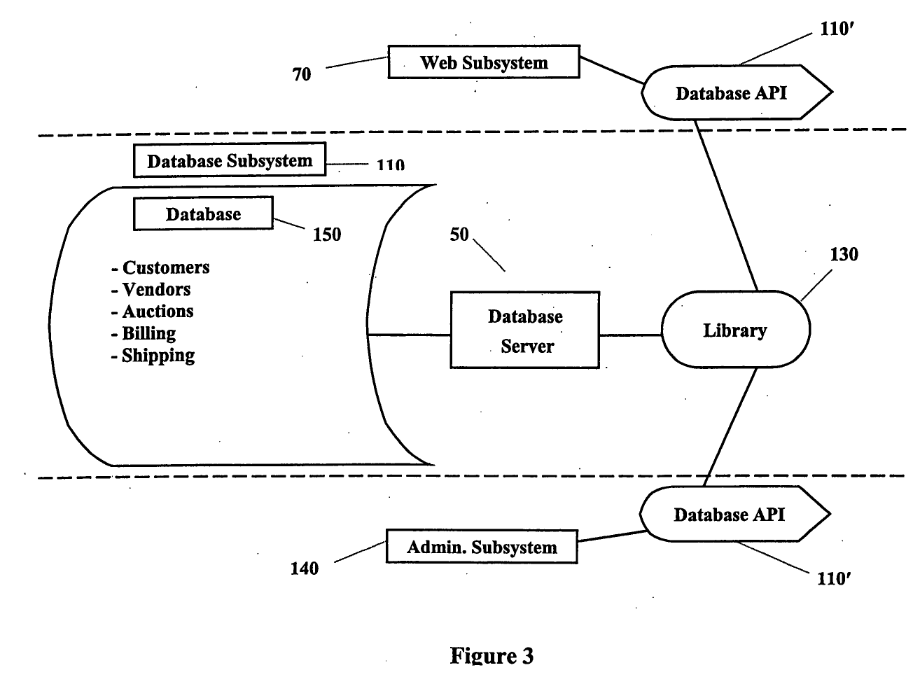

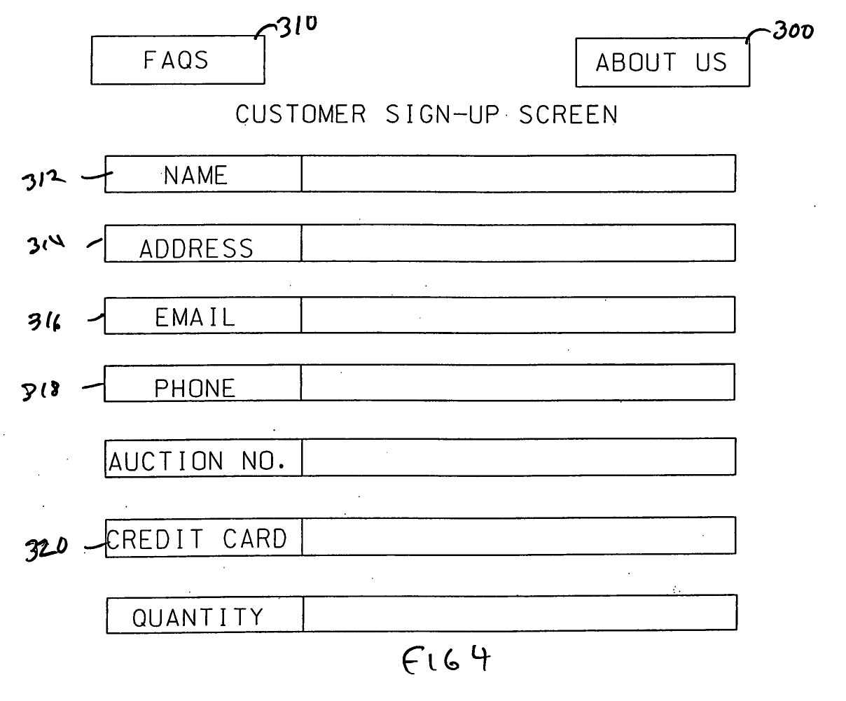

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server. The system further includes an administrative work station 60 or system which provides the administrative capabilities and monitoring for the system under the control of an administrative subsystem 140. The administrative work station 60 allows administrators or other operators to perform routine operations which affect the entire system and to set up and operate the auctions. Such operations include, but are not limited to, administering the accounts of end users 16, 18 monitoring the traffic through the system.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system.

All systems listed above are preferably communicated via an Ethernet 100 base T network and a switching hub. In addition, a second isolated network segment will preferably exist between the web server 40 and the external communications hardware (e.g. internet router).

The web server 40 is the point of entry to the entire system. The system determines the identity of the users 16, 18 and makes appropriate decisions while serving web pages to the end users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment.

The operators of the system may create, delete and update account information by utilizing the administrative subsystem 140 in administration work station 60. A billing subsystem 100 is used for charging the vendor to sign up for the auction.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database.

In a preferred embodiment, the database subsystem 110 stores all pertinent information pertaining to user accounts, administrator accounts, the auctions, as well as general dynamic system information. All interactions with the database subsystem 110 are performed through a database API 110 which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18. End users 16, 18 may be notified by phone, fax, email or pager, or other communications devices which can be contacted by the system 135. End users 16, 18 will also have a password accessed section of a website where they can access information relevant to their activities and be provided with detailed reports.

Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. A group notification may comprise a special premium or the addition of new auctions 16, 18. The billing subsystem 100 will be used to verify and bill credit cards and communicate through the billing API 100 to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs planner and provider setup and account creation information, stores itineraries and changes made to that information, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

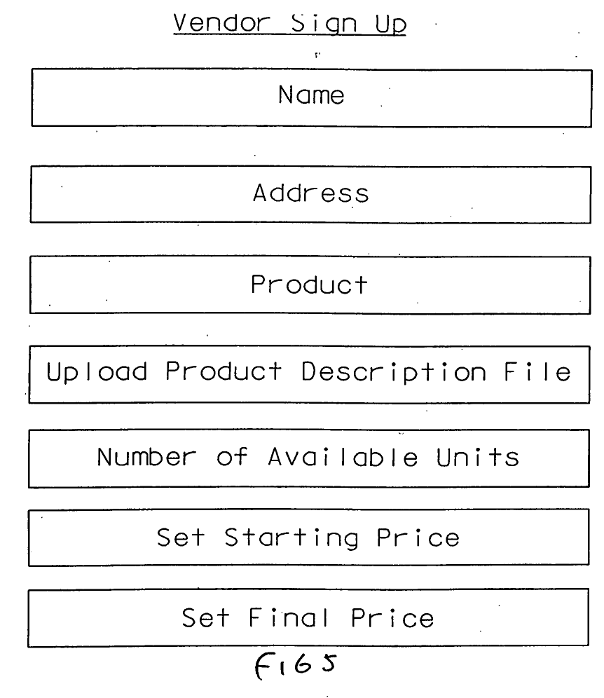

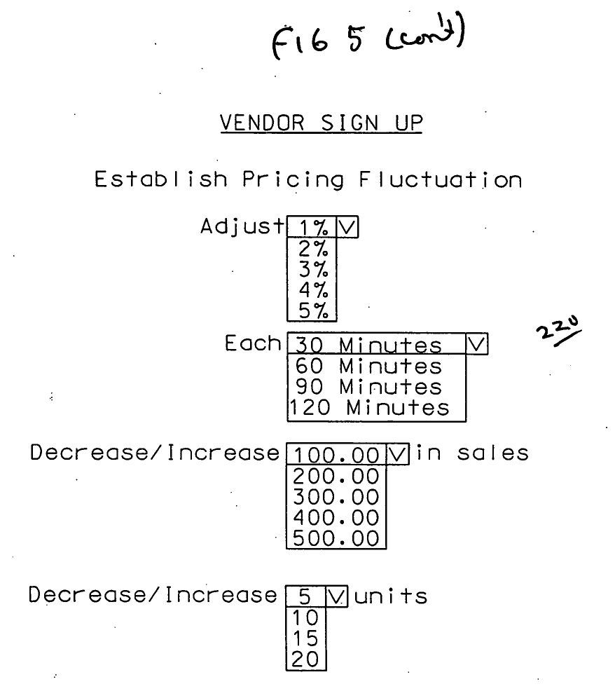

The present invention is now described with reference to FIGS. 4 through 9. The screens of the invention are now shown and are used in conjunction with a website or application. As noted, the present invention may be described in the context of an Internet-based interface. The interface includes both a vendor and a purchaser log-in area. Both log-in areas lead to respective vendor and customer start pages as shown in FIGS. 4 and 5.

The start pages to be discussed in greater detail below, will comprise private or semi-private areas of the site in which the vendors and customers can store their respective data and information. The areas may be password protected and include a place where the vendor can enter the information regarding the products.

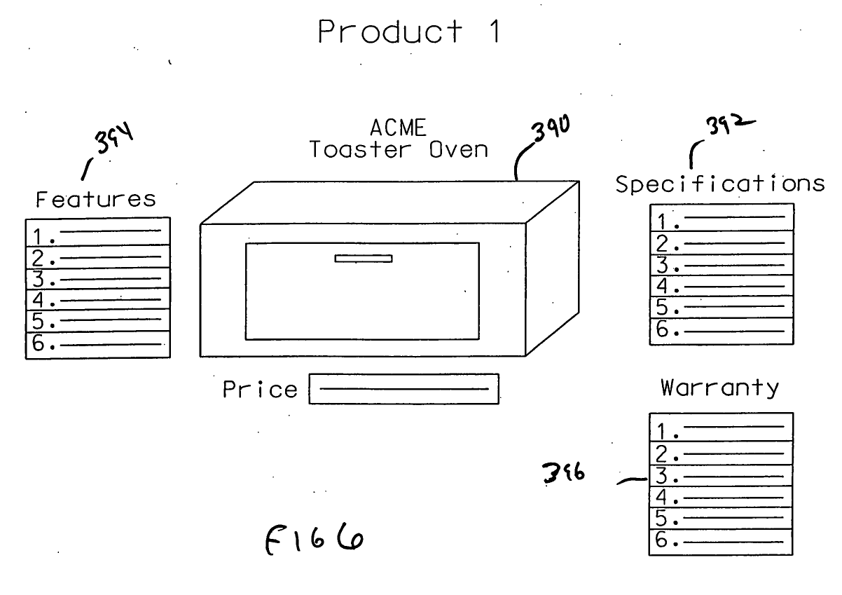

As shown in FIG. 5, the vendor page permits the vendor to set the prices 200 of the product and to further set both maximum 202 and minimum prices 204. As shown in FIG. 5, the Start Page permits the vendor to activate his account, to post products and prices. He will set a price he is agreeable to receive for the product. The vendor can also determine the basis for raising or lowering prices, i.e., according to time, dollar volume or units sold 220. The vendor will then be able to sell all of his products at a guaranteed discount price or to receive a higher price based upon the auction price. As shown in FIG. 6, the vendor area also allows the vendor to input or upload information regarding his products, including a photo 390 specifications 392, features 394 and warranty information 396.

As shown in FIG. 4, the customer screen is accessible via the web browser of the end users comprises an introduction which will introduce the service 300 to the end user. This page will preferably include information (Frequently Asked Questions) 310 and areas for customers to sign up or register. The registration information will include name 312, address 314, email 316, phone 318, and credit card 320.

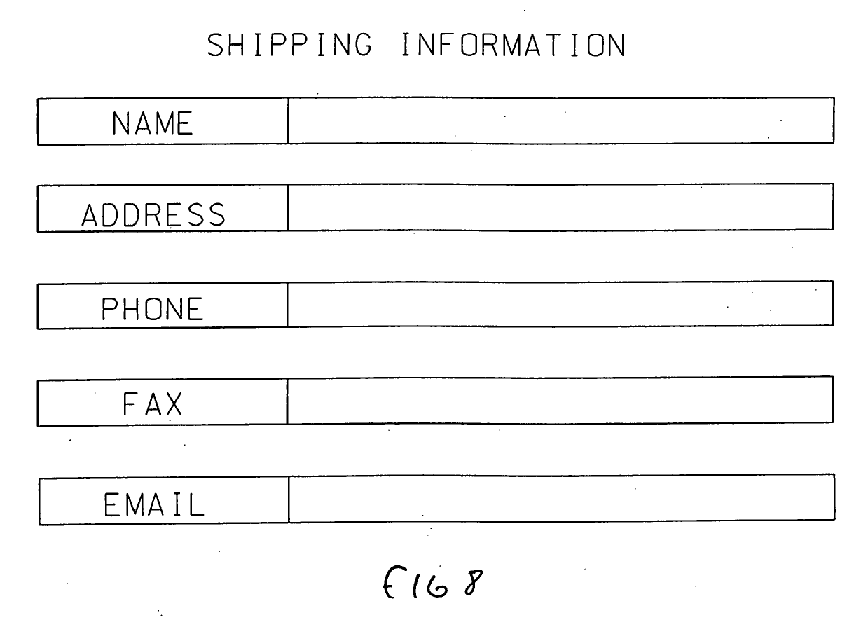

In one embodiment, If the vendor agrees to the guaranteed price, the system will set a default pricing scheme to secure a profitable sales thus passing the process of FIG. 8. The default system may be set by the administrator 40 to automatically adjust pricing based upon pre-set variables.

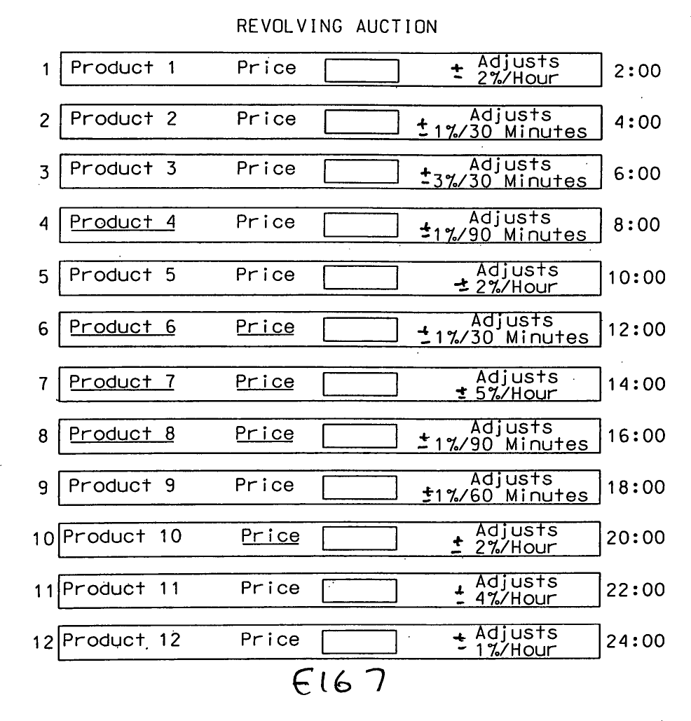

Referring to FIG. 7, the auction is set up to generate for a pre-set period of time. The period in one embodiment is twenty-four (24) hours, although other time periods may be set, such as for twelve (12) hours. Throughout the auction, the price of the product will change or according to a pre-set time or based upon sales 370. This may be based upon time and/or the volume of sales. When the price reaches a minimum point, it will stop decreasing. As sales increase and time, the price will rise according to the preset algorithm of the customer 372. The pricing can be set to adjust according to time, dollar sales volume, or the number of units. The system can be set up to run a multitude of auctions. As shown in FIG. 7, each auction may be for 24 hours and rotate position on a visual presentation after an order is made.

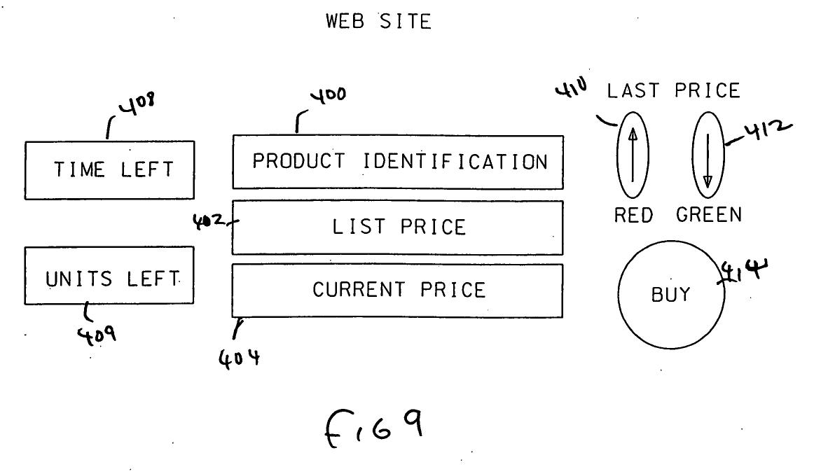

In another embodiment shown in FIG. 9, the invention comprises a single auction embodiment. In this embodiment, a single product may be placed for sale. The screen will identify the product 400, provide a list price 402 and then a current selling 404 amount price 486. The screen will 406 illustrate the amount of time left for the auction 408 and the number of units remaining 410, 412. Two lights, one red and one green, will indicate whether the last selling price was higher or lower. In this way, the prospective customer can see whether the price is falling or rising. A buy button 414 enables the customer to purchase the product. The present embodiment facilitates the use of the embodiment as a link from affiliate websites which may participate. In a further embodiment, an historic record of price fluctuations may be included and shown.

As each order is placed, as shown in FIG. 8, the vendor ships the product. In this way, the auction center is not obligated to ship. The fundamental function of the invention then operates such that the sale of the product continues for a period of add and drop.

The present invention has been described with reference to the above preferred embodiments. The true nature of the invention is to be determined with reference to the attached claims.

1. An method for controlling an auction and sale of products between a vendor and a seller comprising:
placing an item for sale on an auction site such that the price of the item fluctuates according to a preset algorithm based upon time and the level of sales;
completing a sale of at least one of the items; and
delivering the goods to the customer.

2. An interface for controlling a live auction comprising:
a vendor interface for permitting at least one vendor to place products for sale and to set a price which fluctuates based upon time or demand;
a customer interface wherein a customer may order and purchase products and observe whether the price is rising or lowering;
and a delivery system to deliver the purchased product;

3. An method for controlling an auction and sale of products between a vendor and a seller comprising:
placing an item for sale on an auction site such that the price of the item fluctuates according to a preset algorithm based upon time and the level of sales;
indicating whether the price is rising or lowering, based upon a previous sale price;
completing a sale of at least one of the items; and
delivering the goods to the customer.

4. An interface for controlling a live auction comprising:
a vendor interface for permitting a plurality of vendors to place products for sale and to set a price which fluctuates based upon time and demand;
a customer interface wherein a customer may order and purchase products;
and a delivery system to deliver the goods
